(19) United States
(12) Patent Application Publication
(10) Pub. No.: US 2026/0148468 A1
(43) Pub. Date: May 28, 2026

(54) SYSTEM AND METHOD FOR SEMANTICALLY-DRIVEN IMMERSIVE TELEPRESENCE

(71) Applicant: George Mason University, Fairfax, VA (US)

(72) Inventors: Bo Han, Rockville, MD (US); Ruizhi Cheng, Fairfax, VA (US); Nan Wu, Fairfax, VA (US)

(73) Assignee: George Mason University, Fairfax, VA (US)

(21) Appl. No.: 19/402,430

(22) Filed: Nov. 26, 2025

Related U.S. Application Data
(60) Provisional application No. 63/725,021, filed on Nov. 26, 2024.

(51) Int. Cl. G06T 15/00; G06T 7/20; G06T 7/90; G06T 13/40; G06T 17/00; H04N 7/15

(52) U.S. Cl. CPC G06T 15/00; G06T 7/20; G06T 7/90; G06T 13/40; G06T 17/00; H04N 7/157

(57) ABSTRACT

A semantic-driven immersive telepresence system for bandwidth-efficient transmission of three-dimensional human representations. The system extracts compact semantic details from captured image data instead of transmitting complete raw 3D content. Color semantics are derived by estimating scene lighting characteristics using a lightweight model, combined with pre-captured base skin and clothing color. Motion semantics are extracted via keypoint detection of body joints, facial features, and hand positions. A regression-based method using keypoint-anchored vertices (KAVs) maps sparse keypoints to parametric human model parameters in real-time. The system transmits compressed semantic information over networks and reconstructs human representations at receiving devices. A multi-stage neural rendering pipeline with patch-based processing generates photo-realistic visual output. The approach significantly reduces bandwidth requirements compared to traditional bit-by-bit transmission of point clouds or meshes while maintaining low latency, real-time performance, and high visual quality suitable for interactive telepresence applications.

### CROSS-REFERENCE TO RELATED APPLICATIONS

This application claims benefit to Provisional Application No. 63/725,021, filed Nov. 26, 2024, the contents of which are herein incorporated by reference.

### STATEMENT REGARDING FEDERALLY SPONSORED RESEARCH

This invention was made with government support under grant number 2212296 awarded by the National Science Foundation. The government has certain rights in the invention.

### BACKGROUND OF THE INVENTION

### Field of Endeavor

The present invention relates generally to immersive telepresence systems and, more particularly, to systems and methods for bandwidth-efficient transmission and real-time rendering of three-dimensional (3D) human representations for remote communication utilizing semantics.

### Background of Related Art

Immersive telepresence represents a transformative approach to remote communication, offering highly interactive and engaging user experiences by enabling participants to perceive and interact with remote individuals as three-dimensional representations in shared virtual spaces. Unlike traditional video conferencing, immersive telepresence supports six degrees of freedom (6 DoF) motion, allowing users to not only change viewing directions but also move freely in 3D space. This capability has driven adoption across diverse domains including healthcare (such as telesurgery), education, professional training, scientific data visualization, remote collaboration, and entertainment.

The technical foundation of immersive telepresence typically involves real-time capture, creation, delivery, and rendering of immersive content using multiple RGB-D (Red-Green-Blue plus Depth) cameras positioned to cover different viewing angles. These cameras capture the three-dimensional form and appearance of users, which are then synthesized into 3D representations such as textured meshes or point clouds. A mesh consists of interconnected vertices forming a cohesive structure that incorporates both geometry (defining shape and structure) and texture (providing surface details such as color). Point clouds, alternatively, comprise discrete points with associated color information distributed in 3D space.

Despite its promise, achieving truly immersive and highly interactive telepresence experiences presents significant technical challenges:

Bandwidth Requirements: Due to the inherently three-dimensional nature of immersive content, streaming high-fidelity representations demands substantial network bandwidth. For example, existing systems such as Holoportation require throughput exceeding 1 gigabit per second (Gbps). State-of-the-art point-cloud-based telepresence systems typically consume approximately 70 megabits per second (Mbps), which exceeds the standard broadband service offering in the United States (25 Mbps) and is substantially higher than average bandwidths available in many regions globally. Large portions of Africa and Asia have average Internet broadband bandwidth below 15 Mbps, with some regions operating below 1 Mbps.

Latency Constraints: The interactive nature of immersive telepresence necessitates ultra-low end-to-end latency for live content delivery, typically requiring one-way communication delays under 100 milliseconds (ms) to maintain natural interaction and avoid perceptible lag that degrades user experience.

Frame Rate Requirements: Real-time delivery of immersive content requires maintaining streaming rates of at least 30 frames per second (FPS), corresponding to processing times of less than 33 ms per frame, to ensure fluid motion and continuity in user interactions. Lower frame rates result in jerky, discontinuous motion that severely impacts quality of experience (QoE).

Network Variability: Contemporary Internet infrastructure may not adequately support the bit-by-bit transmission of raw data required for immersive telepresence. Sudden bandwidth fluctuations are common and can significantly degrade QoE. The mismatch between required and available bandwidth represents a fundamental barrier to widespread adoption of immersive telepresence technologies.

Existing solutions for immersive content delivery have predominantly focused on video-on-demand services that distribute pre-recorded content. While live immersive content delivery offers compelling applications for telepresence, current approaches rely on traditional bit-by-bit communication of raw 3D data, leading to the bandwidth constraints described above.

Point Cloud Streaming: Systems that transmit point clouds must communicate large volumes of discrete 3D points with associated color information. Even with compression techniques, streaming approximately 200,000 points per frame at 30 FPS consumes substantial bandwidth while providing only moderate visual quality. Increasing point density to improve visual fidelity (for example, to 700,000 or more points per frame) proportionally increases bandwidth requirements and computational overhead, making real-time performance difficult to achieve on resource-constrained mobile devices.

Mesh-based Transmission: While 3D meshes can provide more structured representations than point clouds, transmitting complete mesh geometries and associated texture information also requires significant bandwidth. Direct texture mapping approaches that transmit high-resolution, multi-view RGB-D images for applying textures to meshes can require 30+ Mbps, yet still produce poor visual quality due to limitations in mesh geometry accuracy.

Reconstruction Techniques: Existing methods for reconstructing 3D human representations from captured data face challenges in real-time performance. Optimization-based approaches for estimating parametric human model parameters, while accurate, operate at extremely low frame rates (less than 0.02 FPS), making them unsuitable for interactive applications. Image-centric methods offer faster execution but still require approximately 200 ms per frame—far exceeding real-time requirements.

Rendering Limitations: Achieving photo-realistic rendering of reconstructed 3D content in real-time presents additional challenges, particularly when working with sparse geometric representations such as parametric meshes with limited vertex counts (for example, approximately 10,000 vertices). Traditional rendering techniques struggle to produce high-quality visual output from such sparse data without substantial computational overhead.

There exists a need in the art for immersive telepresence systems that can dramatically reduce Internet bandwidth consumption while simultaneously maintaining low end-to-end latency, achieving real-time frame rates, and preserving high visual quality. Such systems would enable broader adoption of immersive telepresence applications by making them accessible over standard broadband connections and in bandwidth-constrained environments globally. Furthermore, there is a need for approaches that can efficiently extract essential information from captured 3D data, transmit compact representations of that information, and accurately reconstruct high-quality immersive content at receiving devices in real-time.

The present invention addresses these needs by introducing a semantic-driven approach to immersive telepresence that transmits only meaningful semantic details of users rather than complete raw 3D content, achieving dramatic reductions in bandwidth usage while maintaining the quality of experience required for effective remote communication.

### SUMMARY OF THE INVENTION

Embodiments of the present invention include a system, method, and computer readable medium for generating immersive telepresence data using semantic data. The immersive telepresence system comprises multiple image capture devices, at least one user device, and at least one edge computing device with a processor executing specific modules. The edge computing device receives image data from the capture devices and processes it through three primary modules: an extraction module that derives both color semantics and motion semantics from the images; a reconstruction module that estimates parametric model parameters from the motion semantics; and a rendering module that generates a parametric human model, creates output images by combining the model with color semantics, refines these images, and transmits the final results to the user device. The system may also include a user profiling phase where initial images are collected prior to the telepresence session.

The corresponding computer-implemented utilizes an estimation model to extract color semantics, a detection model to extract motion semantics, and deep learning models to estimate model parameters. The method generates a parametric model from these parameters, produces output images by integrating the model with color semantics, refines the images using a neural rendering model, and transmits the refined images to a user device. The invention is also embodied as a non-transitory computer-readable medium storing instructions that execute this same method when run by a processor.

### BRIEF DESCRIPTION OF THE DRAWINGS

FIG. 1 is a schematic diagram of a system for semantically driven immersive telepresence, according to aspects of the present invention;

FIG. 2 is a flow diagram of a method semantically driven immersive telepresence, according to aspects of the present invention; and

FIG. 3 is an illustration deep learning models for estimating model parameters of a parametric model, according to aspects of the present invention.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

Current immersive telepresence systems face a critical bandwidth-efficiency paradox: delivering high-quality, interactive three-dimensional representations of remote users requires transmitting massive volumes of raw 3D data, resulting in bandwidth demands that exceed what contemporary Internet infrastructure can reliably provide in many deployment scenarios.

Broadly, an embodiment of the present invention provides an immersive telepresence system. The system of the present invention includes image capture device(s) for capturing and processing images of a user, edge computing device(s) for processing and transmitting telepresence data, and user device(s) for rendering telepresence data.

Broadly, the image capture device(s) are device(s) that capture image data of a user for use in generating telepresence data. The image capture device(s) can be camera(s), such as but not limited to, a grayscale camera, a red, green, blue (RGB) camera, or another suitable type of camera. The camera(s) may depth (D) information, such as in the example of a grayscale-D camera or a RGB-D camera. The camera(s) may update (capture images) at a predetermined frequency, such as 60 hertz (Hz), 120 Hz, or another suitable frequency. Additionally, the image device(s) can include a computing device for processing captured image data of the user, and converting the image data for use in generating telepresence data.

Broadly, the edge computing device(s) is a computing device having modules, engines, processes, etc., configured to process image data and generate telepresence data therefrom. The modules include, but are not limited to, an extraction module for extracting semantic data from image data, a reconstruction module for generating model parameters from at least a portion of the semantic data, and/or a rendering module for rendering telepresence data using the model parameters and at least a portion of the semantic data.

Broadly, the modules can include model(s), algorithm(s), etc., for processing, extracting, estimating, etc., data needed for generating telepresence data. The model(s) include, but are not limited to, an estimation model for extracting color semantics from image data, a detection model for extracting motion semantics from image data, one or more parameter estimation model(s) for determining model parameters of a parametric model, and/or a neural rendering model for refining telepresence data.

Broadly, the user device(s) is a computing device for rendering telepresence data provided by the edge computing device. The user device can be a personal digital assistant (PDA), desktop workstation, laptop or notebook computer, netbook, tablet, smart phone, smart glasses, smart watch or other wearable, appliance, part of the Internet-of-Things, and/or embedded system, to name a few non-limiting examples, or any combination thereof.

Broadly, an embodiment of the present invention provides a method for generating immersive telepresence data. The method receives image data items, and extracts semantic data from the image data items, such as color semantics, and/or motion semantics. The semantic data can be extracted, using models such as an estimation model for extracting color semantics, and/or a detection model for extracting motion semantics. Model parameters are estimated using at least a portion of the semantic data, such as the motion semantics. Model parameters can be estimated utilizing deep learning models trained on motion data. A parametric model of a user, or image, is generated using the model parameters, which along with another portion of the semantic data, such as the color semantics, is used to generate output images. The output images are refined utilizing a neural rendering model and are transmitted to a user device for rendering, as immersive telepresence data.

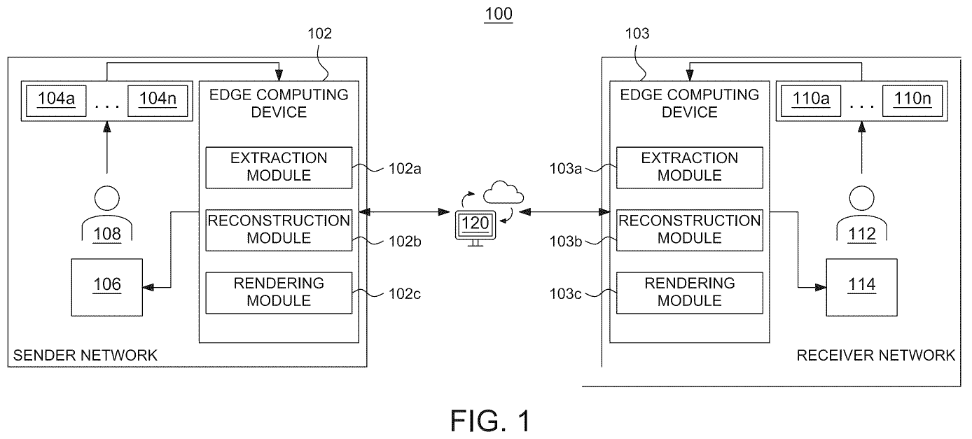

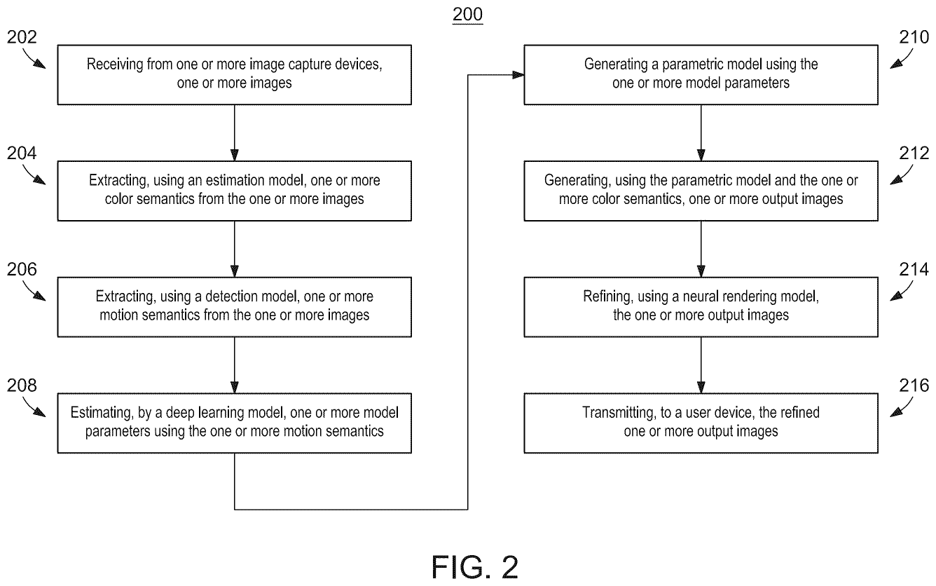

Referring now to the Figures, the Figures illustrate aspects of a system and method of immersive telepresence, according to aspects of the present invention. Briefly, FIG. 1 illustrates a system for immersive telepresence 100 including image capture devices 104a-104, and 110a-110n for capturing and processing image data of users 108, and 112, respectively. Image data is provided to Edge computing device(s) 102 and/or 103 for processing, and rendering of telepresence data, through modules 102a-102c and 103a-103c, and provided to user devices 106 and 114 for viewing by users 108, and 112 respectively. Briefly, FIG. 2 illustrates a method for immersive telepresence 200, which can be performed by system 100, or one or more components thereof.

FIG. 1 illustrates a system for immersive telepresence 100, according to aspects of the present invention. System 100 includes one or more components for processing image data and rendering telepresence data between users, such as a sender 108 and a receiver 112, such as, but not limited to image capture devices 104a-104n, image capture devices 110a-110n, at least one edge computing device 102 and/or 103, and user devices, such as sender user device 106 and receiver user device 114. System 100 data, such as image data, sematic data, telepresence data, etc., are transmitted to/from sender/receiver through a communications network 120, such as the Internet. More specifically, system 100 realizes immersive telepresence through semantic communication by extraction of semantics at the sender, transmission over the communications network, and re-construction of immersive content from derived semantics at the receiver.

Image capture devices 104a-104n and/or 110a-110n are positioned at each of a sender site and a receiver site and are configured to capture images of users in real-time, such as sender 108 and/or receiver 112, for creation, delivery and rendering of immersive content. Image capture devices 104a-104n and/or 110a-110n are positioned at both the sender site and the receiver site in varied locations to capture different viewing angles of users, such as sender 108 and/or receiver 112. Additionally, each of the capture devices 104a-104n and/or 110a-110n can include a computing device for processing captured image data of the user, and converting the image data for use in generating telepresence data.

In embodiments, the image capture devices 104a-104n and/or 110a-110n can be cameras, such as but not limited to, a stereo camera, a grayscale camera, a red, green, blue (RGB) camera, or another suitable type of camera. The cameras may depth (D) information, such as in the example of a grayscale-D camera or a RGB-D camera. The cameras may update (capture images) at a predetermined frequency, such as 60 hertz (Hz), 120 Hz, or another suitable frequency. The cameras may capture images at one or more resolutions.

In exemplary embodiments, image capture devices 104a-104n and/or 110a-110n are RGB-D cameras configured to capture images and/or image data of a user for use in immersive telepresence. In exemplary embodiments, each of image capture devices 104a-104n and/or 110a-110n are each coupled to a computing device for processing images to produce image data and/or depth data. In exemplary embodiments, the computing device is an embedded device, such as an NVIDIA Jetson Xavier NX, which receives images from the image capture devices and process the images to generate image data, and/or depth data, and transmits the generated image data, and/or depth data to the at least one edge computing device 102 and/or 103.

Edge computing device(s) 102 and 103 are computing devices having modules thereon configured to process received data, such as image data, and/or depth data, and generate telepresence data therefrom. The modules include, but are not limited to, an extraction module for extracting semantic data from image data, a reconstruction module for generating model parameters from at least a portion of the semantic data, and/or a rendering module for rendering telepresence data using the model parameters and at least a portion of the semantic data.

In embodiments, Edge computing device(s) 102 and 103 are located at the edge of a communications network, such as communications network 120, communicatively proximate to a data source, such as sender and/or receiver. System 100 illustrates two edge computing devices, one for the sender, and one for the receiver, but the architecture is not so limited, as a singular edge computing device can service both sender and receiver. Additionally, communication network 120 can be composed of multiple disparate communications networks, and user devices can be connected to their respective edge computing device utilizing a separate communications network. Additionally, modules of each edge computing device can be segregated across multiple edge computing devices, such as in a cloud configuration.

Referring now to the functionality of Edge computing device(s) 102 and 103. Each of Edge computing devices 102 and 103 can include one or more modules configured to process image data and generate telepresence data therefrom. In embodiments, the one or more modules can include model(s), algorithm(s), etc., for processing, extracting, estimating, etc., data needed for generating telepresence data. It is understood, that Edge computing device(s) 102 and 103 can each include all, or a subset of the modules described herein.

Extraction module 102a-103a are configured to receive data from Image capture devices 104a-104n, and 110a-110n, respectively, and extract semantic data therefrom. In embodiments, Extraction module 102a-103a receives image data, such as images of sender 108 and/or receiver 112, and depth data associated with the image data, from Image capture devices 104a-104n, and 110a-110n and extracts color semantics and motion semantics therefrom. In embodiments, image data and depth data are of a user, or users, such as sender 108 and/or receiver 112, engaging in a telepresence session using system 100.

Extraction module 102a-103a includes functionality to extract color semantics from image data provided by Image capture devices 104a-104n and/or 110a-110n and/or their associated computing devices. In embodiments, color semantics are extracted as one or more base colors in the image data, and one or more lighting characteristics. In embodiments, the one or more base colors are extracted from one or more features of the image data. In embodiments, a skin and/or clothing of the user are the one or more features.

In embodiments, the one or more lighting characteristics are extracted using an estimation model, being a lightweight deep learning model. In an exemplary embodiment, the lightweight deep learning model is lighting estimation framework, such as Xihe, configured to receive the image data and to output a coefficient vector representing comprehensive lighting characteristics of the image data. In the exemplary embodiment, the coefficient vector is a 27-dimension vector. Additionally, the estimation model is fine-tuned at run-time within initial image data, i.e. user profiling data, and the fine-tuning is supervised utilizing an accurate, diffusion-based, and face-centered lighting estimation model. In embodiments, specific features of the image data are utilized for base color extraction, and/or lighting estimation. In the exemplary embodiment, facial features are utilized for light estimation, instead of those of other body parts, due to their higher accuracy and robustness.

The frequency of estimating and delivering light characteristics is contingent upon the specific lighting conditions of system 100. For instance, in settings exposed to sunlight, more frequent updates are needed due to the dynamic nature of natural light. Conversely, in indoor environments with stable artificial light and limited changes in the intensity and number of light sources, less frequent up-dates are sufficient. Nevertheless, the representation of lighting characteristics as a compact coefficient vector allows for efficient data communication.

Extraction module 102a-103a includes functionality to extract motion semantics from image data provided by Image capture devices 104a-104n and/or 110a-110n and/or their associated computing devices. In embodiments, motion semantics are extracted as one or more keypoints of a user in image data. Specifically, the one or more keypoints represent the geometry of the body of the user, and are captured across frames of image data. These motion semantics are essentially driven by the articulation of bones and joints, which are inherently complex, and as such only certain points are captured. For example, by extracting the position of each joint in the user's hand and tracking these positional changes, as motion semantics, hand movements are accurately captured.

In embodiments, motion semantics are captured, as two-dimensional keypoints of a user in image data, by one or more pose estimation models. In embodiments, the one or more pose estimation models are a lightweight pose estimation framework, trained on images of humans, and configured to detect human body keypoints in image data, such as joints, facial features, and/or hand positions. In an exemplary embodiment, the one or more pose estimation models utilize the OpenPose framework, and/or the MediaPipe framework.

Upon extraction, by extraction module 102a-103a, color semantics and/or motion semantics are provided to further modules of system 100 for reconstruction and rendering of telepresence data. In embodiments, either or both of color semantics or motion semantics are compressed or encrypted prior to being provided to further modules of system 100.

Reconstruction module 102b-103b are configured to receive keypoint data and estimate one or more parameters for use in building one or more parametric models of the user.

Use of a parametric model enables accurate modeling of human movements over time. The one or more parametric models are extensively pre-trained on vast video datasets to capture a wide array of human movement patterns, enabling them to accurately and smoothly model human motion in various poses. In an exemplary embodiment, the one or more parametric models are one or more SMPL-X parametric models with fully articulated hands and an expressive face. The output of SMPL-X is a 3D mesh comprising a number of vertices, such as 10,475 vertices. Additionally, the spatial position of each vertex is determined by one or more SMPL-X parameters and its linear blend skinning (LBS) weights, which controls how the vertex deforms in response to body movements.

Reconstruction module 102b-103b estimates the one or more parameters of the one or more parametric models, in real-time, using deep learning models. In embodiments, a regression method is utilized to create the deep learning models are regression trained deep learning models that can estimate the one or more parameters in real-time from the keypoint data provided.

In embodiments, regression method trains the deep-learning model which establishes a relationship between the input keypoints and the output parametric model, such as a SMPL-X mesh, through the one or more parameters, which control the generation of the model. However, directly establishing an accurate mapping between keypoints and a parametric model, such as a SMPL-X mesh is non-trivial, as typically more vertices exist than keypoints detected.

To address this problem, the regression method adds an augmentation before training: for each keypoint, a corresponding vertex is added to the first ground-truth parametric model. For example, given a keypoint on the left wrist, included a vertex added to the parametric model at the same position. In essence, this alignment becomes an indicator of accuracy in training. As a consequence, the reconstructed parametric model accurately reflects the human form when any detected keypoints naturally align with their corresponding vertices in the model, even when the keypoints move independently over time along with body motion. In embodiments, to enable such correspondence, additional vertices are to the parametric model, rather than seeking correspondence in it, as certain keypoints'locations/coordinates may not align with any existing vertices of the model.

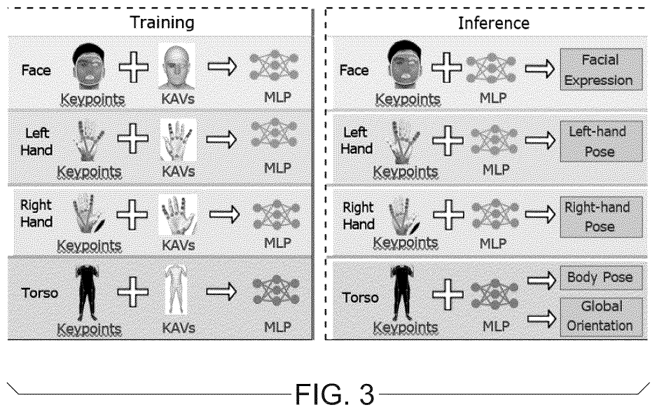

The newly added vertices, termed keypoint-anchored vertices (KAVs), act as conduits. As shown in FIG. 3, they directly connect keypoints with the output parametric model, and thus aid in the precise estimation of SMPL-X parameters. KAVs are only added to the first ground truth parametric model. For each keypoint, a vertex is added to the model based on the keypoint's 3D coordinates. For each added vertex vₖ, its nearest vertex v_{g} is found on the parametric model and assign the LBS weight of v_{g} to vₖ. By doing this, it ensures that KAVs can be controlled by estimated one or more parameters and realistically deformed in harmony with the surrounding vertices. For models of other frames, KAVs are reused from the previous one while extracting keypoints from newly captured images to align with those KAVs.

By building the connection between the keypoints and the SMPL-X mesh, a lightweight model is trained to estimate the one or more parameters from these keypoints without compromising accuracy. In an exemplary embodiment, a five-layer multilayer perception (MLP) model is designed and four parallel instances are deployed for the left hand, right hand, face, and torso. To ensure that the output the parametric model faithfully replicates the actual body pose, facial expressions, and hand gestures captured by the keypoints over time, the mean squared error (MSE) between the one or more parameters and their ground truth, as well as the mean per-joint position error (MPJPE) between each keypoint and its corresponding KAV is minimized. In the exemplary embodiment, supervision of the training of the regression method is performed.

Upon estimation of the one or more parameters, by reconstruction module 102a-103a, the one or more parameters are provided to further modules of system 100 for rendering of telepresence data. In embodiments, the one or more parameters are compressed or encrypted prior to being provided to further modules of system 100.

Rendering module 102c-103c is configured to receive the one or more parameters and the color semantics and to render telepresence data therefrom.

Rendering module 102c-103c obtains photo-realistic visual quality by utilizing neural rendering, an emerging rendering paradigm that utilizes a deep-learning model to achieve high-quality rendering from sparse input data (e.g., parametric models, such as meshes) or images. Specifically, Rendering module 102c-103c implements a two-stage rendering process including (1) rasterization and (2) image-based neural rendering.

Prior to rasterization, the parametric model is generated using the one or more model parameters. In embodiments, the parametric model is a SMPL-X model, but is not so limited. After the model is generated, rasterization takes the color semantics, such as the one or more base colors, and the one or more lighting characteristics to generate basic telepresence data. In embodiments, the basic telepresence data is one or more 2D images, or frames.

After rasterization, an image based neural rendering model refines the basic telepresence data into final telepresence data, such as photo-realistic telepresence data. In embodiments, as neural rendering is computationally expensive and time consuming, a patch-based acceleration strategy, which updates only specific portions of the human body with noticeable changes, balancing the need for real-time performance and high visual quality for immersive telepresence is utilized.

To identify patches of the human body, or image, needing update a movement distance is calculated each vertex in the re-constructed parametric model. When the distance exceeds a threshold there is a noticeable change requiring update. In embodiments, different thresholds can be set for different body parts.

The neural rendering model can be a deep learning model, such as a Convolutional Neural Network (CNN), but is not so limited. In an exemplary embodiment, the neural rendering model is based on the U-Net framework. In the exemplary embodiment, the neural rendering model is trained on the results of the rasterization step, while utilizing images from the Image capture devices 104a-104n, and/or 110a-110n, as ground truths for supervised learning.

Rendering module 102c-103c outputs the results of image based neural rendering to the user devices as telepresence data. It is understood that in the context of FIG. 1 separate sender and receiver devices, such as edge computing devices, and their functionality have been described. However, it is envisioned that differing configurations, such as a singular edge computing device, are contemplated, and additionally, that sender 108 can be a receiver, and receiver 110 can be a sender.

User devices, such as sender user device 106 and receiver user device 114, can be computing devices, and are configured to render telepresence data generated by Edge computing device(s) 102 and 103. In embodiments, user devices, can be smart devices, such as smartphones, smart glasses, etc., running one or more modules, or programs, for rendering telepresence content. In an exemplary embodiment, user devices are smart headsets, such as Microsoft Hololens running a graphics engine, such as Unreal Engine which is configured to render telepresence data.

FIG. 2 illustrates a computer-implemented method 200 for generating immersive telepresence data according to aspects of the present invention. Method 200 represents a semantic-driven approach to immersive telepresence that dramatically reduces bandwidth consumption while maintaining real-time performance and high visual quality. The method can be executed in whole or in part by system 100 illustrated in FIG. 1, including edge computing devices 102 and 103, but the method is not limited to this particular system architecture. Method 200 implements semantic communication principles by extracting meaningful semantic details of users rather than transmitting complete raw three-dimensional content, enabling efficient telepresence over standard broadband connections and bandwidth-constrained networks.

At step 202, method 200 begins by receiving one or more image data items from image capture devices positioned at a sender site or receiver site. The image data items can include one or more images captured in real-time of users participating in an immersive telepresence session. In embodiments, the image data items are received from a plurality of RGB-D cameras, such as image capture devices 104a-104n or 110a-110n, positioned at various locations and angles to capture different viewing perspectives of the user. Each image data item may include both color information in the form of RGB images and depth information indicating the three-dimensional spatial position of objects and surfaces within the captured scene. In embodiments, the one or more images are processed to generate structured image data and depth data that is transmitted to at least one edge computing device for further processing.

The received image data items represent data from which semantic information will be extracted in subsequent steps. Unlike traditional immersive telepresence systems that would compress and transmit this raw data directly, method 200 processes these image data items to extract only the meaningful semantic details necessary for reconstructing high-quality representations of the user at a remote location.

At step 204, method 200 extracts one or more color semantics from the received image data items using an estimation model. Color semantics represent the essential information needed to accurately reproduce the visual appearance of the user, specifically the color characteristics of skin and clothing as they appear under the lighting conditions present in the telepresence environment and/or the lighting conditions themselves. Rather than transmitting complete texture information or high-resolution color data for every frame, method 200 derives compact semantic representations of color that can be efficiently transmitted and used for reconstruction at the receiving device.

In embodiments, the estimation model used for extracting color semantics is a lightweight deep learning model, specifically a lighting estimation framework such as Xihe. The estimation model receives the image data items as input and outputs a coefficient vector representing comprehensive lighting characteristics of the scene. In exemplary embodiments, the coefficient vector is a compact 27-dimensional vector that encapsulates the lighting information using spherical harmonics representation, enabling efficient encoding of complex lighting environments including multiple light sources, ambient illumination, and directional lighting components.

The lighting estimation model may be fine-tuned during an initial user profiling phase conducted prior to the telepresence session. During this profiling phase, participants are asked to perform simple movements, such as spinning in a circle for approximately 10-20 seconds, in front of the image capture devices. The data gathered during this profiling is used to fine-tune the lighting estimation model specifically for the deployment environment and the individual user. This fine-tuning process is supervised using an accurate, diffusion-based, and face-centered lighting estimation model that provides ground truth lighting information. The use of facial features for lighting estimation, rather than features from other body parts, is preferred due to the higher accuracy and robustness of face-based lighting analysis.

In embodiments, color semantics extraction also includes obtaining one or more base colors from specific features of the image data, such as the skin and clothing of the user. These base colors can be extracted during the user profiling phase using existing techniques and stored for use throughout the telepresence session, as they remain relatively constant. The combination of base colors and lighting characteristics constitutes the complete color semantics needed to accurately render the user's appearance.

At step 206, method 200 extracts one or more motion semantics from the received image data items using a detection model. Motion semantics represent the essential information describing the geometry and movement of the user's body over time, capturing the dynamic aspects of human motion that are critical for creating realistic and interactive telepresence experiences. Rather than transmitting complete three-dimensional mesh data or dense point clouds for every frame, method 200 derives compact representations of body motion through the detection and tracking of specific keypoints on the human body.

In embodiments, motion semantics are extracted as two-dimensional keypoints detected in the image data items, with associated depth information from the RGB-D cameras enabling the derivation of three-dimensional keypoint positions. The detection model used for extracting motion semantics is a lightweight pose estimation framework trained on large datasets of human images and configured to detect human body keypoints in real-time. In exemplary embodiments, the detection model utilizes frameworks such as OpenPose or MediaPipe, which provide comprehensive keypoint detection capabilities across the full body, hands, and face.

The keypoints detected at step 206 serve as motion semantics that capture the temporal dynamics of human movement across consecutive frames of video. Unlike single-frame reconstruction approaches that process each frame independently, the keypoint-based motion semantics enable accurate modeling of human motion over time, avoiding temporal discontinuity and visual artifacts that would degrade quality of experience. The detected keypoints provide sufficient information to drive parametric human models that can smoothly represent complex body movements, hand gestures, and facial expressions throughout the telepresence session.

Upon extraction, the motion semantics in the form of keypoint data may be compressed or encrypted prior to transmission to subsequent processing stages or to remote devices. Even without compression, the data size of keypoints is substantially smaller than alternative representations such as dense point clouds or complete mesh geometries.

At step 208, method 200 estimates one or more model parameters using the motion semantics extracted in step 206, employing one or more deep learning models specifically designed for real-time parameter estimation. The model parameters control a parametric human model that accurately represents the three-dimensional form and motion of the user's body. This step transforms the sparse keypoint data into a comprehensive representation that can capture the full complexity of human form, including body pose, hand articulation, and facial expressions, while maintaining temporal consistency across frames.

In embodiments, the deep learning models used for parameter estimation comprise lightweight multilayer perceptron (MLP) architectures. In an exemplary embodiment, four parallel five-layer MLP models are deployed, with each model specializing in a different region of the body: left hand, right hand, face, and torso/global orientation. This parallel architecture enables efficient processing of different body parts simultaneously while allowing each model to specialize in the particular characteristics and movement patterns of its assigned region. The relatively simple MLP architecture, combined with the sparse keypoint input, enables real-time performance substantially faster than prior approaches.

During inference at step 208, the trained deep learning models receive the three-dimensional keypoint data extracted in step 206 and rapidly estimate the parametric model parameters. The estimated model parameters are comprehensive, capturing body pose, hand articulation, facial expressions, and global orientation. For an SMPL-X parametric model, these parameters include pose parameters that control joint rotations, shape parameters that adjust body proportions, expression parameters that control facial expressions, and global orientation and translation parameters that determine overall position and orientation in three-dimensional space. The complete set of parameters provides sufficient information to generate a detailed three-dimensional mesh representation of the user in the specific pose, with the specific hand gestures, and with the specific facial expression captured in the current frame.

Upon estimation, the model parameters may be compressed using techniques such as LZMA compression prior to transmission to the rendering module or to remote devices. The compressed parameter data requires substantially less bandwidth than alternative representations.

At step 210, method 200 generates a parametric model of the user using the model parameters estimated in step 208. The parametric model provides a structured three-dimensional representation of the human body that accurately captures body shape, pose, hand articulation, and facial expressions in the current frame. Unlike generic three-dimensional meshes or point clouds, parametric models leverage extensive pre-training on large datasets of human motion to provide anatomically plausible and temporally consistent representations that can accurately model human movements over time.

In embodiments, the parametric model is generated using the SMPL-X (Skinned Multi-Person Linear Model with eXpressive hands and face) framework, though other parametric human models could be employed. The SMPL-X parametric model is extensively pre-trained on vast datasets of video captures showing diverse human subjects performing a wide array of movement patterns. This pre-training enables the model to accurately and smoothly represent human motion across various poses, activities, and expressions. The model encodes prior knowledge about human anatomy, biomechanical constraints, and typical movement patterns, ensuring that generated representations are anatomically plausible and exhibit realistic deformations during motion.

The output of the SMPL-X parametric model generated at step 210 is a three-dimensional mesh comprising a fixed topology of interconnected vertices. In exemplary embodiments, the mesh contains 10,475 vertices arranged in a structure that represents the complete human body including detailed hand geometry and facial structure. Each vertex in the mesh has a defined three-dimensional spatial position that is determined by the model parameters estimated in step 208 combined with the vertex's linear blend skinning (LBS) weight.

LBS weights control how each vertex deforms in response to body movements such as joint rotations and skeletal articulation. When model parameters specify particular joint angles or facial expression coefficients, the LBS weights determine how each vertex in the mesh moves and deforms to create the overall body pose and expression. This skinning approach enables smooth, realistic deformations that follow anatomical constraints and produce natural-looking human forms across diverse poses and expressions.

The generation of the parametric model mesh from the estimated parameters is a computationally efficient process because the SMPL-X model has a fixed topology and employs linear blend skinning with pre-defined weights. Unlike parameter estimation, which requires complex deep learning inference, mesh generation involves primarily matrix operations and vertex transformations that can be executed very rapidly.

Importantly, the parametric model generated at step 210 provides temporal consistency across frames. Because the SMPL-X model is driven by parameters that evolve smoothly over time based on the keypoint tracking from step 206, the resulting mesh representations maintain continuity between consecutive frames. This temporal consistency avoids artifacts such as sudden jumps, discontinuities, or unrealistic deformations that would occur with single-frame reconstruction approaches that process each frame independently without considering motion dynamics. The smooth temporal behavior is essential for achieving high quality of experience in immersive telepresence where users perceive motion continuously over time.

While the parametric model mesh provides accurate geometric representation of body shape and pose, it contains only geometry information without associated texture or color details. The mesh defines the three-dimensional structure but does not specify what color or appearance those surfaces should have when rendered.

The generated parametric model mesh serves as the geometric foundation for rendering in the following steps. Its sparse nature, containing only approximately 10,000 vertices compared to the potentially millions of points in dense point cloud representations or high-resolution depth maps, enables efficient processing and transmission. However, this sparsity also means that simply rendering the mesh directly using traditional graphics techniques would produce low-quality results lacking fine details and photo-realistic appearance. Therefore, the mesh must be processed through the neural rendering pipeline described in subsequent steps to achieve the high visual quality necessary for immersive telepresence applications.

At step 212, method 200 generates one or more output images using the parametric model generated in step 210 and the color semantics extracted in step 204. This step represents the first stage of a two-stage rendering pipeline that transforms the sparse geometric representation of the parametric model into visual content that can be displayed to users. The output images generated at step 212 are initial renderings that incorporate both the geometric structure of the user's body and the color appearance determined by lighting characteristics and base colors, but these initial renderings are coarse and lack the fine details and photo-realistic quality necessary for high-quality immersive telepresence.

The rendering approach employed at step 212 is rasterization, i.e. converting three-dimensional geometry into two-dimensional images. Rasterization operates by projecting the vertices of the three-dimensional mesh onto a two-dimensional image plane corresponding to the desired viewing perspective, determining which pixels in the output image correspond to visible surfaces of the mesh, and computing color values for those pixels based on surface properties and lighting models.

The rasterization process at step 212 incorporates the color semantics extracted in step 204 to determine the appearance of rendered surfaces. Specifically, the one or more base colors representing the inherent color of the user's skin and clothing, which were obtained during user profiling and remain constant throughout the telepresence session, are combined with the lighting characteristics represented by the compact coefficient vector (such as the 27-dimensional spherical harmonics coefficients) to compute the perceived color at each point on the mesh surface. This combination models the physical interaction between surface materials and illumination, approximating how light reflects from surfaces to produce the colors observed by a viewer.

In embodiments, the output images generated at step 212 are rendered at resolutions appropriate for the target display devices and quality of experience requirements. In exemplary implementations, the rendering resolution is set at 1280×720 pixels, which has been demonstrated in prior research to provide satisfactory quality of experience for telepresence applications while maintaining computational efficiency that enables real-time performance. Higher resolutions such as 1920×1080 pixels (Full HD) or beyond may be employed depending on available computational resources and display capabilities of user devices.

The rasterization process at step 212 is designed to handle multiple viewpoints, enabling the six degrees of freedom (6 DoF) motion that is characteristic of immersive telepresence. Users wearing head-mounted displays or other viewing devices can move freely in three-dimensional space and observe the remote user from any angle, not just from fixed camera positions. The rasterization process can generate appropriate views by adjusting the projection and viewing transformation applied to the parametric model, rendering the mesh from whatever viewpoint corresponds to the local user's current position and orientation in the virtual space.

The output images generated at step 212 through rasterization are coarse renderings that capture the basic geometric structure and approximate color appearance of the user but lack fine details, surface textures, and the photo-realistic quality necessary for high-quality telepresence. The sparse nature of the parametric model mesh, containing only approximately 10,000 vertices, limits the geometric detail that can be directly represented. Additionally, simple lighting models used in rasterization, while computationally efficient, cannot capture complex light transport phenomena such as subsurface scattering in skin, fine texture details in clothing, or subtle color variations across surfaces. Therefore, these initial rasterized output images serve as input to the neural rendering refinement process in step 214, which enhances them to achieve photo-realistic quality.

At step 214, method 200 refines the one or more output images generated in step 212 using a neural rendering model to produce photo-realistic final telepresence data with high visual quality suitable for immersive communication applications. This refinement step represents the second stage of the two-stage rendering pipeline and is critical for transforming the coarse rasterized images into compelling visual representations that provide satisfactory quality of experience for users. Neural rendering leverages deep learning to overcome the limitations of traditional graphics techniques when working with sparse geometric data, learning to synthesize fine details, realistic textures, and subtle visual effects that cannot be directly computed from the parametric model mesh alone.

The neural rendering model employed at step 214 is an image-based deep learning model that operates on two-dimensional images rather than three-dimensional geometric data. In embodiments, the neural rendering model is based on a U-Net architecture, a convolutional neural network originally designed for image segmentation tasks but widely adopted for image-to-image translation applications. U-Net features an encoder-decoder structure with skip connections that preserve fine-grained spatial information during processing. The encoder progressively down-samples the input image while extracting hierarchical feature representations at multiple scales, capturing both low-level details and high-level semantic content. The decoder then progressively up-samples these features back to the original resolution while combining information from corresponding encoder layers through skip connections, enabling the network to synthesize output images that preserve spatial structure and fine details from the input while incorporating learned enhancements.

The neural rendering model is trained using supervised learning during an initial training phase that occurs before telepresence sessions. Training data consists of pairs of images where the input is a coarse rasterized rendering of the parametric model mesh with applied color semantics (similar to the output from step 212), and the ground truth target is a high-quality photograph of the actual user captured by the RGB cameras at the sender site under the same pose and lighting conditions.

At step 214 a patch-based acceleration strategy that selectively updates only portions of the rendered image showing noticeable changes between frames is utilized. Rather than processing the entire image through the computationally intensive neural rendering model for every frame, the patch-based approach identifies which regions need updating and applies neural rendering only to those patches, reusing rendered results from the previous frame for unchanged regions.

The patch identification process operates by calculating movement distances for each vertex in the parametric model mesh generated in step 210. By comparing vertex positions between the current frame and the previous frame, the system determines which vertices have moved by distances exceeding predefined thresholds. Different thresholds may be established for different body parts based on perceptual importance and typical movement patterns. For example, facial regions may use more sensitive thresholds because even small movements can convey important communicative information and should trigger re-rendering. When vertices in a particular region of the mesh show movement exceeding the threshold, the corresponding patch or patches in the rendered image are marked for neural rendering update.

The patch-based approach enables parallel processing of multiple patches simultaneously, further improving efficiency. When multiple patches require updating in a given frame, they can be processed concurrently rather than sequentially, reducing overall rendering latency. This parallel processing capability is particularly valuable for handling scenarios where multiple body parts are moving simultaneously, such as during dynamic gestures or dance movements.

At step 216, method 200 transmits the refined one or more output images produced in step 214 to at least one user device for display to users participating in the immersive telepresence session. This transmission completes the telepresence communication pipeline, delivering high-quality visual representations of remote users to local viewing devices where they can be rendered in immersive three-dimensional environments. The transmission employs standard network communication protocols and may traverse various network infrastructures including local area networks, wide area networks such as the Internet, cellular networks, or combinations thereof.

In embodiments where the neural rendering is performed by an edge computing device at the receiver side, as illustrated in the exemplary system architecture of FIG. 1, the transmission at step 216 involves communication from the edge computing device 102 or 103 to the associated user device 106 or 114. This communication may occur over a direct network connection such as WiFi, Ethernet, or other local connectivity with low latency and high bandwidth.

In alternative embodiments, the division of processing responsibilities between edge computing devices and user devices may differ from the exemplary architecture of system 100. For instance, if computational resources permit, portions of the rendering pipeline could be executed on the user devices themselves. In such configurations, step 216 might involve transmitting intermediate representations such as parametric model parameters and color semantics to user devices where rendering is performed locally. The flexibility to distribute processing across system components enables optimization for different deployment scenarios with varying resource constraints and network conditions.

The user devices receiving the transmitted refined images are computing devices capable of displaying immersive telepresence content to users, such as user devices 106 and/or 114.

The transmission at step 216 may incorporate quality of service (QoS) mechanisms to prioritize telepresence traffic on networks, ensuring low latency and minimizing packet loss that could degrade visual quality or introduce perceptible lag. Given the interactive nature of telepresence applications and the requirement for end-to-end latency below 100 milliseconds to maintain natural communication, minimizing transmission delay is critical. The refined images may be packetized using protocols optimized for real-time communication such as Real-time Transport Protocol (RTP) or variants thereof.

In embodiments, the transmission may include metadata accompanying the image data, such as timestamps indicating when each frame was captured and processed, synchronization information for aligning audio and video streams, or pose information describing the position and orientation of the rendered content within the three-dimensional telepresence environment. This metadata assists user devices in properly presenting the content and maintaining synchronization across multiple media streams.

Security and privacy considerations may be addressed through encryption of transmitted data using standard cryptographic protocols such as Transport Layer Security (TLS) or Datagram Transport Layer Security (DTLS). Encryption protects the visual representations of users from interception or unauthorized access during transmission across potentially untrusted networks, which is particularly important for telepresence applications in sensitive domains such as healthcare or confidential business communications.

Upon completion of step 216, method 200 has successfully transformed captured image data of a user at a sender location into high-quality immersive telepresence content delivered to a receiver location, achieving this transformation with dramatic reductions in bandwidth consumption while maintaining real-time performance and visual quality suitable for interactive communication applications. The method may then repeat for subsequent frames, continuously processing the stream of image data to provide ongoing telepresence experiences.

In embodiments, method 200 operates bidirectionally, with symmetric implementations at both sender and receiver locations enabling two-way communication where each participant sees a high-quality immersive representation of the other. In such bidirectional configurations, steps 202 through 216 execute concurrently in both directions, with each location serving simultaneously as sender (capturing and transmitting its own user) and receiver (receiving and rendering the remote user). The system architecture illustrated in FIG. 1 supports such bidirectional operation with image capture devices, edge computing devices, and user devices deployed at both locations.

Method 200 represents a fundamental advancement in immersive telepresence technology and provides an efficient and effective approach to immersive remote communication suitable for diverse applications including teleconferencing, remote collaboration, telemedicine, education, training, and entertainment.

Embodiments of the invention and all of the functional operations described in this specification can be implemented in digital electronic circuitry, or in computer software, firmware, hardware, or a combination thereof, including the structures disclosed in this specification and their structural equivalents, or in combinations of one or more of them. Embodiments of the invention can be implemented as one or more computer program products, e.g., one or more modules of computer program instructions encoded on a computer readable medium for execution by, or to control the operation of, data processing apparatus. The computer readable medium can be a machine-readable storage device, a non-transitory machine-readable storage device, a machine-readable storage substrate, a memory device, a composition of matter effecting a machine-readable propagated signal, or a combination of one or more of them. The term “computing device” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as a program, software, software application, script, or code) can be written in any form of programming language, including compiled or interpreted languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Generally, a computer will also include a communications device. The communication device can include hardware and/or software for generating and communicating signals over a direct and/or indirect network communication link. As used herein, a direct link can include a link between two devices where information is communicated from one device to the other without passing through an intermediary. For example, the direct link can include a Bluetooth™ connection, a Zigbee connection, a Wifi Direct™ connection, a near-field communications (“NFC”) connection, an infrared connection, a wired universal serial bus (“USB”) connection, an ethernet cable connection, a fiber-optic connection, a firewire connection, a microwire connection, and so forth. In another example, the direct link can include a cable on a bus network. An indirect link can include a link between two or more devices where data can pass through an intermediary, such as a router, before being received by an intended recipient of the data. For example, the indirect link can include a WiFi connection where data is passed through a WiFi router, a cellular network connection where data is passed through a cellular network router, a wired network connection where devices are interconnected through hubs and/or routers, and so forth. The cellular network connection can be implemented according to one or more cellular network standards, including the global system for mobile communications (“GSM”) standard, a code division multiple access (“CDMA”) standard such as the universal mobile telecommunications standard, an orthogonal frequency division multiple access (“OFDMA”) standard such as the long term evolution (“LTE”) standard, and so forth.

Moreover, a computer can be embedded in another device, e.g., a tablet computer, a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the invention can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the invention, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

It should be understood, of course, that the foregoing relates to exemplary embodiments of the invention and that modifications may be made without departing from the spirit and scope of the invention as set forth in the following claims.

What is claimed is:

1. An immersive telepresence system, comprising:
a plurality of image capture devices;
at least one user device; and
at least one edge computing device, having at least one processor and memory storing instructions that when executed cause the processor to perform a method, the method comprising:
receiving, from the plurality of image capture devices, one or more image data items;
extracting, by an extraction module, one or more color semantics from the one or more image data items;
extracting, by the extraction module, one or more motion semantics from the one or more image data items;
estimating, a reconstruction module, one or more model parameters using the one or more motion semantics;
generating, by a rendering module, a parametric model using the one or more model parameters;
generating, by the rendering module, one or more output images using the parametric model and the one or more color semantics;
refining, by the rendering module, the one or more output images; and
transmitting, to the at least one user device, the refined one or more output images.

2. The immersive telepresence system of claim 1, wherein the one or more color semantics comprise one or more base colors and one or more lighting characteristics.

3. The immersive telepresence system of claim 2, wherein the one or more base colors are extracted from skin and clothing features of a user captured in the one or more image data items.

4. The immersive telepresence system of claim 1, wherein the extraction module extracts the one or more lighting characteristics using a lighting estimation model configured to output a coefficient vector representing comprehensive lighting characteristics of a scene.

5. The immersive telepresence system of claim 1, further comprising:
collecting, using a user profiling module, one or more images of a user during an initial profiling phase prior to a telepresence session.

6. The immersive telepresence system of claim 5, further comprising:
extracting one or more additional color semantics from the one or more images collected during the initial profiling phase.

7. The immersive telepresence system of claim 1, wherein the refining, by the rendering module, the one or more output images, further comprises:
refining, by the rendering module, one or more portions of the one or more output images having changes exceeding a threshold.

8. A computer implemented method of generating immersive telepresence data, comprising:
receiving one or more image data items;
extracting, using an estimation model, one or more color semantics from the one or more image data items;
extracting, using a detection model, one or more motion semantics from the one or more image data items;
estimating, by one or more deep learning models, one or more model parameters using the one or more motion semantics;
generating a parametric model using the one or more model parameters;
generating, using the parametric model and the one or more color semantics, one or more output images;
refining, using a neural rendering model, the one or more output images; and
transmitting, to a user device, the refined one or more output images.

9. The method of claim 8, wherein the one or more color semantics comprise one or more base colors and one or more lighting characteristics.

10. The method of claim 9, wherein extracting the one or more color semantics comprises extracting the one or more base colors from skin and clothing features visible in the one or more image data items.

11. The method of claim 8, wherein the estimation model comprises a lighting estimation framework configured to output a coefficient vector representing comprehensive lighting characteristics.

12. The method of claim 8, further comprising:
collecting, using a user profiling module, one or more images of a user during an initial profiling phase prior to a telepresence session.

13. The method of claim 12, further comprising:
extracting one or more additional color semantics from the one or more images collected during the initial profiling phase.

14. The method of claim 8, wherein the refining, by the rendering module, the one or more output images, further comprises:
refining, by the rendering module, one or more portions of the one or more output images having changes exceeding a threshold.

15. A non-transitory computer readable medium storing instructions that when executed by a processor perform a method, the method comprising:
receiving one or more image data items;
extracting, using an estimation model, one or more color semantics from the one or more image data items;
extracting, using a detection model, one or more motion semantics from the one or more image data items;
estimating, by one or more deep learning models, one or more model parameters using the one or more motion semantics;
generating a parametric model using the one or more model parameters;
generating, using the parametric model and the one or more color semantics, one or more output images;
refining, using a neural rendering model, the one or more output images; and
transmitting, to a user device, the refined one or more output images.

16. The non-transitory computer readable medium of claim 15, wherein the one or more color semantics comprise one or more base colors and one or more lighting characteristics.

17. The non-transitory computer readable medium of claim 15, wherein extracting the one or more color semantics comprises extracting the one or more base colors from skin and clothing features visible in the one or more image data items.

18. The non-transitory computer readable medium of claim 15, wherein the estimation model comprises a lighting estimation framework configured to output a coefficient vector representing comprehensive lighting characteristics.

19. The non-transitory computer readable medium of claim 15, further comprising:
collecting, using a user profiling module, one or more images of a user during an initial profiling phase prior to a telepresence session.

20. The non-transitory computer readable medium of claim 19, further comprising:
extracting one or more additional color semantics from the one or more images collected during the initial profiling phase.
